(19) United States
(12) Patent Application Publication
(10) Pub. No.: US 2025/0282413 A1
(43) Pub. Date: Sep. 11, 2025

(54) Apparatus and Method for Optimizing at Least One Feedback into a Steering System of the Vehicle via a Surface Driven on by a Vehicle, the Vehicle Comprising the Apparatus

(71) Applicant: Robert Bosch GmbH, Stuttgart (DE)

(72) Inventors: Stefan Gruener, Auenwald (DE); Theophane Christ Nguedia Nguemo, Schwaebisch Gmuend (DE)

(21) Appl. No.: 19/059,578

(22) Filed: Feb. 21, 2025

(30) Foreign Application Priority Data
Mar. 11, 2024 (DE) 10 2024 202 270.5

(51) Int. Cl. B62D 5/00

(52) U.S. Cl. CPC B62D 5/006

(57) ABSTRACT

A method is for optimizing at least one feedback into a steering system of a vehicle from a surface driven on by the vehicle. When the surface is driven on by the vehicle, a temporal progression of an excitation at a tie rod of the steering system by the surface and a temporal progression of the at least one feedback of the steering system are measured. A temporal target progression of the feedback is determined as a function of the measured temporal progression of the excitation. A measure for the optimization of the at least one feedback is determined as a function of a comparison of the temporal progression of the at least one feedback with the target temporal progression. The at least one feedback is optimized as a function of the measure.

This application claims priority under 35 U.S.C. § 119 to patent application no. DE 10 2024 202 270.5, filed on Mar. 11, 2024 in Germany, the disclosure of which is incorporated herein by reference in its entirety.

The disclosure proceeds from an apparatus and method for optimizing at least one feedback into a steering system of the vehicle via a surface driven on by a vehicle, and a vehicle comprising the apparatus.

### BACKGROUND

In a Steer by Wire (SbW) vehicle, the wheels and the steering wheel are only connected by electrical signals. A torque exerted by a driver on the steering wheel therefore has no direct mechanical influence on the wheels. The SbW system is comprised of two parts: an upper part that receives the driver requests via the steering wheel and a lower part that is mechanically connected to the vehicle wheels. The direction specification is detected by the driver from the upper part and transmitted to the lower part. The lower part is responsible for the lateral movements of the steered axle.

### SUMMARY

The apparatus, method and vehicle disclosed herein systematically optimizes feedback felt by the driver on the steering wheel, which replaces mechanical transmission of surface excitations, in particular road excitations, via the tie rod to the steering wheel.

Surface excitations in this context include forces caused by deformation or imperfections of a surface, particularly a roadway, on the steering system.

The method for optimizing at least one feedback into a steering system of the vehicle via a surface driven on by a vehicle provides that, when the surface is driven on by the vehicle, a temporal progression of an excitation at a tie rod of the steering system by the surface and a temporal progression of the at least one feedback of the steering system are measured, wherein a temporal target progression of the feedback is determined as a function of the measured temporal progression of the excitation, wherein a measure for the optimization of the at least one feedback is determined as a function of a comparison of the temporal progression of the at least one feedback with the temporal target progression, and the at least one feedback is optimized as a function of the measure.

The excitation includes, for example, a force or moment at the tie rod of the steering system.

The at least one feedback includes a temporal progression of a force characterizing the excitation at the tie rod or a moment characterizing the excitation on the tie rod, which is reported back to a driver of the vehicle when the surface is driven on by the vehicle with an operating element of the steering system. The measure comprises a component V1, which comprises a transmission of imperfection information from the tie rods to the operating element.

For example, the at least one feedback includes a temporal progression of a signal characterizing the excitation at the tie rod for determining a force characterizing the excitation at the tie rod to be reported back to a driver of the vehicle when driving on the surface, or a torque characterizing the excitation at the tie rod to be reported back to a driver of the vehicle when driving on the surface. Between the operating element and the tie rods, the steering system has an upper part associated with the operating element, and a lower part associated with a toothed rack to move the tie rods. The individual parts include different mechanical properties, controllers, and software functions. Energy and information losses occur in the parts. The signal allows a transmission behavior of the parts to be optimized individually.

It may be provided that the signal characterizes the temporal progression of the tie rod excitation without consideration of a steering ratio of the steering system. The measure includes a component V3 that considers transmission of imperfection information from the tie rods to the output signal of the lower component of the steering system. The quality of transfer depends on mechanical properties, controller specification, and lower component software functions.

It may be provided that the signal characterizes the temporal progression of the tie rod excitation with consideration of the steering ratio of the steering system. The measure comprises a component V2, which describes a transmission of imperfection information from the tie rods to the steering feel signal. The steering feel signal represents an input signal of the upper component of the steering system. The quality of transmission depends in addition to the mechanical properties, controller specification, software functions of the lower component of mechanical properties and controllers for determining the steering feel signal.

It may be provided that an amplitude of the temporal progression of the at least one feedback is compared with an amplitude of the temporal target progression, and the measure for the optimization comprises an in particular average percentage difference of the amplitudes determined as a function of the amplitudes when the surface is driven on by the vehicle.

It may be provided that, depending on the comparison, a time delay between the temporal progression of the at least one feedback and the target temporal progression is determined, and the measure for the optimization comprises the time delay, in particular in milliseconds.

It may be provided that, depending on the comparison, a deformation of the temporal progression of the at least one feedback is determined with respect to temporal target progression, and the measure for the optimization comprises the deformation, in particular as the radius of a circle.

It may be provided that the at least one feedback is optimized depending on the measure for minimization of the deformation.

It may be provided that the at least one feedback is optimized depending on the measure for minimization of the time delay.

It may be provided that the temporal progression of the at least one feedback from the steering system is determined as a function of parameters of at least one controller and/or at least one software function of the steering system, wherein parameters are determined for which the at least one feedback optimizes the measure.

Apparatus and method for optimizing at least one feedback into a steering system of the vehicle via a surface driven on by a vehicle configured to execute the method.

A vehicle may be provided comprising the apparatus.

### BRIEF DESCRIPTION OF THE DRAWINGS

Further advantageous embodiments will become apparent from the following description and the drawing. The drawings show:

FIG. 1 a schematic representation of a part of a vehicle with a steering system,

FIG. 2 an exemplary temporal progression of surface excitations,

FIG. 3 an exemplary temporal progression of feedback from the steering system,

FIG. 4 an exemplary target temporal progression of the feedback,

FIG. 5 exemplary temporal progressions prior to an optimization of the steering system,

FIG. 6 exemplary temporal progressions before and after optimization of the steering system,

FIG. 7 a comparison of vectors describing the temporal progressions, and

FIG. 8 a flow chart showing the steps of a method for optimizing the steering system.

### DETAILED DESCRIPTION

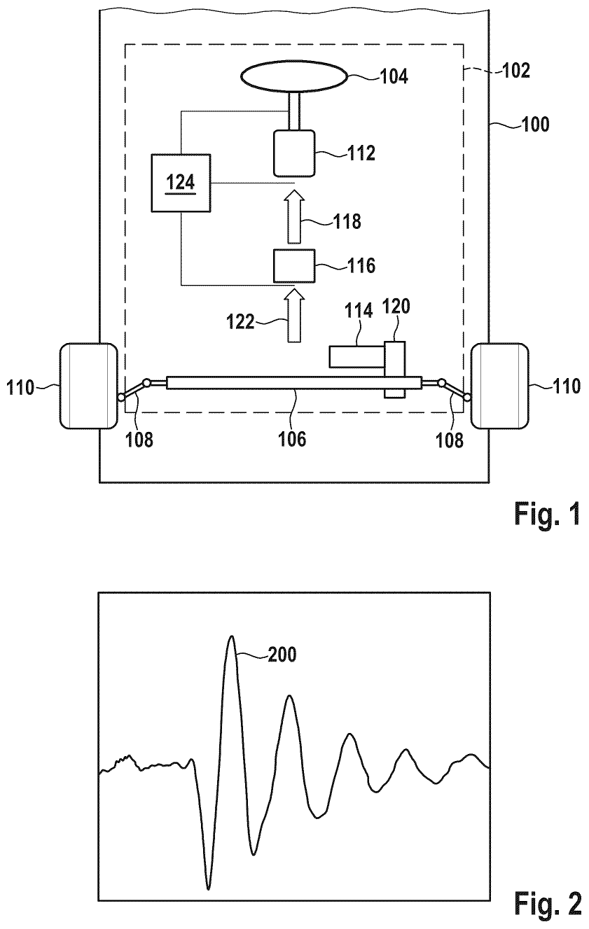

A part of a vehicle 100 having a steering system 102 is schematically illustrated in FIG. 1.

The steering system 102 includes an operating element, in the example a steering wheel 104.

The steering system 102 includes a toothed rack 106 connected to steerable wheels 110 of the vehicle 100 via tie rods 108.

The steering system 102 includes an upper part 112 associated with the operating element and a lower part 114 associated with the toothed rack 106. An interface 116 is provided between the upper part 112 and the lower part 114.

The upper part 112 is configured to detect a target steering angle that a driver of the vehicle 100 adjusts on the operating element.

The upper part 112 is configured to receive a first signal 118 for determining feedback from the steering system to the driver from the interface 116.

The upper part 112 is configured to provide the driver with feedback from the steering system via surface excitations by activating the operating element.

For example, the upper part 112 includes a sensor for detecting the target steering angle. For example, the upper part 112 includes an actuator for outputting the feedback.

The upper part 112 includes at least one controller and/or at least one software function for detecting the target steering angle, determining the feedback as a function of the first signal 118, and outputting the feedback.

The lower part 114 is configured to move the toothed rack 106 via an actuator 120 as a function of a target wheel angle. The tie rods 108 transmit movement of the toothed rack to move the wheels 110 to steer the vehicle 100.

The lower part 114 is configured to determine a second signal 122 for determining feedback as a function of excitation at a tie rod 108 or tie rods 108 through the surface.

The lower part 114 includes at least one controller and/or at least one software function for adjusting the target wheel angle and determining the second signal 122.

In the example, the interface 116 includes at least one controller and/or at least one software function for determining the target wheel angle as a function of the target steering angle and determining the first signal 118 as a function of the second signal 122.

The first signal 116 and the second signal 118 also provide feedback about a surface driven on by the vehicle 100 in the steering system 102 of the vehicle 100. An apparatus 124 for optimizing at least one feedback is configured to perform a method for optimizing at least one feedback described below.

Surface excitations are generally high frequency excitations. The transmission behavior from the wheels 110 to the steering wheel 104 cannot be described by standard methods from linear system theory. This transfer behavior is influenced, for example, by the vehicle speed, the frictional behavior and/or a geometry and/or arrangement of mechanical components and/or actuators of the lower part 114 and the upper part 112, a communication between the lower part 114, the interface 116 and the upper part 112, e.g. a CAN communication.

To optimize the transmission behavior, a measure, i.e., a metric, is defined that allows an assessment of the feedback from the steering system.

The transmission behavior is described independent of the movements initiated by the driver. The manner in which surface excitation is experienced by the driver provides the driver with important information about the vehicle condition, e.g. vehicle speed, and the form of the imperfections.

For example, the transmission behavior is considered on the basis of a tie rod force. Individual road deformations cause vibrations in the tie rod force. The frequency of a particular vibration is dependent on vehicle speed, the distance between imperfections, wheels 110, and chassis characteristics. As the vehicle speed increases but the distance of imperfections remains consistent, the frequency of excitation increases. If the imperfections follow each other very closely, the vibrations in the force signal overlap for a fixed vehicle load. As a result, the form of the individual imperfections on the steering wheel 104 is no longer clearly apparent. The perception of the distance between two imperfections on the steering wheel 104 varies with vehicle speed.

If the vibrations overlap, such as for high vehicle speeds, the driver can no longer separate the individual imperfection excitations from each other. In such situations, the driver may only evaluate the amplitude of the excitation. The other information is mixed or attenuated/deformed by the overlap and therefore cannot be evaluated.

An objective assessment of the feedback from the steering system can only be done objectively and fully in the case of individual obstacles, as in the case of individual obstacles, the driver is able to perceive various aspects of vibration transmission. For example, the driver may evaluate the time difference between the occurrence of the first vibrations on the front axle and the occurrence of the vibrations on the steering wheel. That is, a time delay of the steering system feedback for a particular vehicle speed is relevant.

FIG. 2 shows an exemplary temporal progression of surface excitations 200. The temporal progression of the surface excitations 200 is shown in the example for a defined vehicle speed and a defined obstacle. FIG. 2 shows the temporal progression of the surface excitations 200 as the obstacle is driven over.

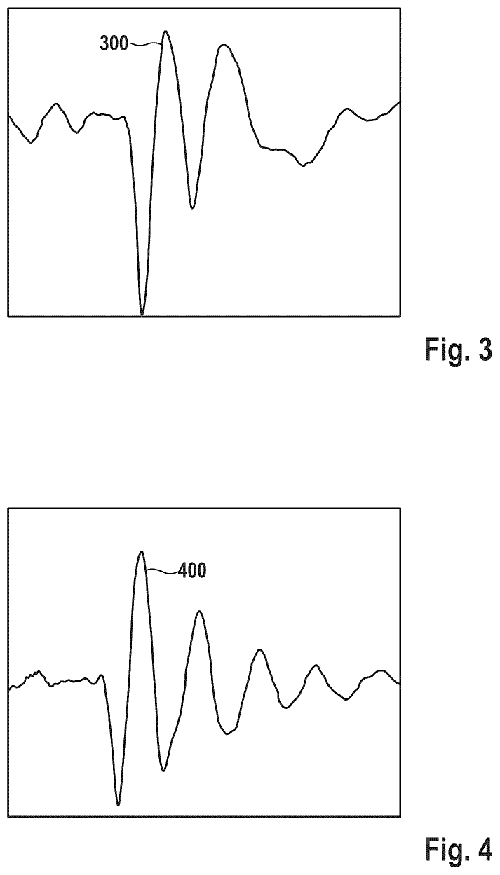

An exemplary temporal progression of feedback 300 of the steering system 102 is shown in FIG. 3. The temporal progression of the feedback 300 is shown in the example for the defined vehicle speed and the defined obstacle. FIG. 3 shows the temporal progression of the feedback 300 as the obstacle is driven over.

In FIG. 4, an exemplary target temporal progression 400 of the feedback is shown. The target temporal progression 400 of the feedback is shown in the example for the defined vehicle speed and the defined obstacle. FIG. 4 shows the target temporal progression 400 of the feedback as the obstacle is driven over.

For a defined vehicle speed, the temporal progression of the feedback of the steering system 300 is compared to the target temporal progression of the feedback 400. Depending on the comparison, a measure for optimizing the feedback is determined.

In the example, in addition to the temporal progression of the feedback 300 of the steering system 102, a temporal progression of the first signal 118 and the second signal 122 as the obstacle is driven over is detected. In the example, in addition to the target temporal progression 400 of the feedback from the steering system 102, a target temporal progression of the first signal 118 and a target temporal progression of the second signal 122 are detected as the obstacle is driven over.

In the example, a part of the measure for the optimization is determined for each target temporal progression. The parts of the measure are each described by a vector representing the behavior of the respective feedback:
V1: temporal progression of the feedback 300 of the steering system 102
V2: temporal progression of the first signal 118
V3 temporal progression of the second signal 122

The respective vector describes the signal through the components: Amplitude transmission, Time delay, Deformation.

The amplitude transmission is a variable calculated from the difference between the amplitude of the respective temporal progression and the amplitude of the respective target progression.

In the example, the time delay is a variable calculated by a combination of group delay and delay of individual extrema of the respective temporal progression compared to the group delay and the extrema of the respective target progression.

In the example, the deformation is a variable estimated from a deviation of the respective temporal progression from the respective target progression.

In the example, one direction of the respective vector describes the amplitude transmission, e.g. in [%]. In the example, an angular direction of the respective vector describes the time delay. A length of the vector describes the deformation in the example.

The ideal amplitude transmission depends on the type of vehicle. The ideal deformation is zero. The time delay and deformation must be minimized. High amplitude transmission values are desired for sports vehicles.

The calculation of the vectors allows a selection of the controller and/or the software function to be modified or parameterized to optimize the respective feedback.

The vector V3 describes the transmission of imperfection information from the tie rods 108 to the second signal 122 that the lower part 114 of the steering system 102 outputs.

The quality of transfer depends on mechanical properties of the lower part and/or controller and/or software functions of the lower part 114.

The vector V2 describes the transmission from the tie rods 108 to the first signal 118, which represents the input signal of the part 112 of the steering system 102.

The quality of transfer depends on controllers and/or software functions of the interface 116 in addition to the mechanical properties and/or controllers and/or software functions of the lower part 114.

In particular, a force calculation or steering feel function of the interface 116 to determine the first signal 118 plays a dominant role in the quality of the transmission.

The vector V1 describes the transmission from the tie rods 108 to the steering wheel 104.

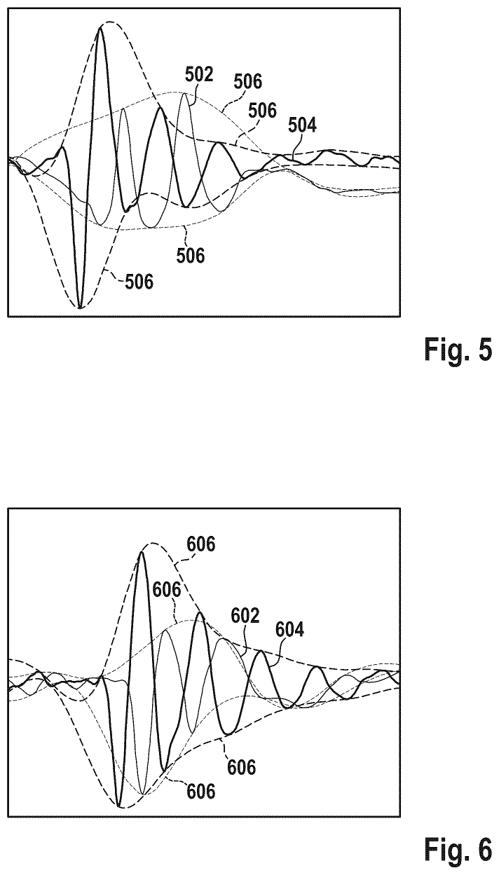

FIG. 5 shows a temporal progression of a measured torque 502 and on the steering wheel 104 and a temporal progression of a target torque 504 on the steering wheel before an optimization of the steering system. FIG. 5 also shows an envelope 506 of the respective temporal progression.

FIG. 6 shows a temporal progression of a measured torque 602 and on the steering wheel 104 and a temporal progression of a target torque 604 on the steering wheel after an optimization of the steering system. FIG. 6 also shows an envelope 606 of the respective temporal progression.

In the example, the target torques are calculated from a respective force measured at the tie rods 108 or a torque measured at the tie rods 108.

The vectors describe the comparison of the respective temporal progressions and form components of the measure for the optimization.

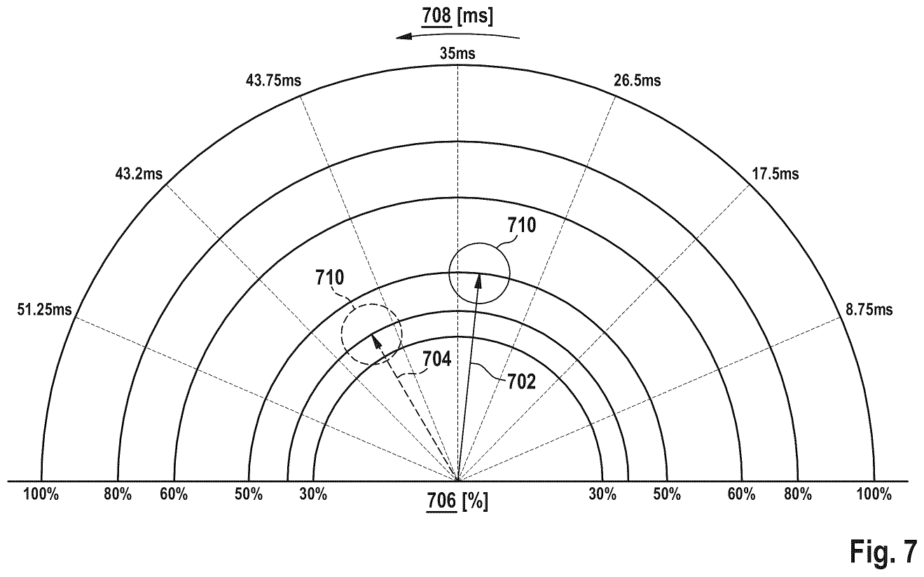

FIG. 7 shows a comparison of a vector 702 describing the temporal progression prior to optimization with a vector 704 describing the temporal progression after optimization, via amplitude transmission 706 in [%] with an indication of the time delay 708 in [ms] and an indication of deformation 710 as the radius of a small circle associated with the peak of the respective vector.

From the comparison of the vectors, it can be seen that the steering system 102 has significantly better amplitude transmission after optimization than that of the steering system 102 after optimization.

In addition, the vector 702, which describes the steering system 102 after optimization, describes both a better distortion behavior and a better deformation behavior than the vector 704, which describes the steering system 102 prior to optimization.

The vectors thus provide metric descriptions of the behavior of the steering system 102 with respect to feedback from the steering system 102 before or after the optimization.

Targeted parameter variations and functional optimizations may optimize the steering system 102 with respect to its feedback.

The respective vector, which describes the overall feedback of the steering system 102, is an example of the vector V1. This vector V1 is divided into the vectors V2, V3 in the example.

The parts of the steering system 102 may be optimized individually or together depending on the vectors. The measure comprises the vector of the part to be optimized or the vectors of the parts to be optimized.

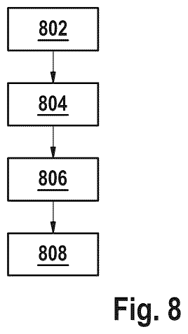

FIG. 8 shows a flowchart with steps of a method for optimizing the steering system 102.

The method comprises a step 802.

In step 802, a temporal progression of excitation at a tie rod 108 of the steering system 102 by the surface and the temporal progression 502 of the feedback from the steering system 102 prior to optimization are measured as the surface is driven on by the vehicle.

In the example, the temporal progression 502 of the feedback is the moment. A different physical variable, e.g., a force, may also be used to characterize the feedback from the steering system 102.

In the example, the excitation is a force or moment on the tie rod 108 of the steering system 102.

In the example, it is provided that the temporal progression of the first signal 118 and the temporal progression of the second signal 122 determined by the steering system 102 as the surface is driven on is detected. The first signal 118 forms the input variable from which the upper part 112 determines the temporal progression 502 of the feedback from the steering system 102. The second signal 122 forms the input variable from which the interface 116 determines the time progression of the first signal 118.

The method comprises a step 804.

In step 804, the target temporal progression 504 of the feedback is determined depending on the measured temporal progression 502 of the excitation.

In the example, the target progression 504 of the feedback is the moment. It can also be provided that a target temporal progression, e.g., the force, which matches the other physical variable is determined.

It may be provided that a respective target progression curve is determined for the first signal 118 and/or the second signal 122 depending on the measured temporal progression 502 of the excitation.

For example, the temporal progression 502 of the at least one feedback from the steering system 102 is determined as a function of parameters of at least one controller and/or at least one software function of the steering system 102.

For example, the temporal progression 502 of the at least one feedback from the steering system 102 is determined as a function of parameters of at least one controller and/or at least one software function of the upper part 112.

Feedback from the steering system 102 optionally depends on the first signal 118 and/or the second signal 122. This means that the temporal progression 502 of the at least one feedback from the steering system 102 is optionally determined as a function of parameters of at least one controller and/or at least one software function of the interface 116 and/or the lower part 114.

The method comprises a step 806.

In step 806, the measure for optimization is determined as a function of a comparison of the temporal progression 502 of the feedback with the target temporal progression 504.

In the example, the vector V1 is determined from the comparison of the time progression 502 of the feedback with the target time progression 504.

It may be provided that the vector V2 and/or V3 is determined for the first signal 118 and/or the second signal 122 as a function of the comparison of the respective measured temporal progression with the respective target progression.

In comparison, for example, the amplitude of the respective temporal progression is compared with the amplitude of the respective target temporal progression, and the respective vector is determined as a function of the difference in the amplitudes. For example, a percent difference in the amplitude of the respective temporal progression is determined from the amplitude of the target temporal progression. In the example, an average percent difference of the respective amplitude of the temporal progression that is measured when the surface is driven on by the vehicle is determined from the amplitude of the target temporal progression.

In comparison, for example, a time delay between the respective measured temporal progression and the respective target temporal progression is determined, and the respective vector is determined as a function of the time delay.

In comparison, for example, a deformation of the temporal progression of the at least respective feedback with respect to the respective target temporal progression is determined, and the respective vector is determined as a function of the deformation. The deformation is indicated as a radius of a respective circle, for example.

This means that the measure comprises the vector V1, which comprises transmitting imperfection information from the tie rods 108 to the operating element, in the example the steering wheel 104. This means that the measure optionally comprises the vector V2 describing a transmission of imperfection information from the tie rods 108 to the first signal 118, in the example a steering feel signal. The steering feel signal represents an input signal of the upper part 112 of the steering system 102 from which feedback from the steering system 102 is determined. Optionally, the measure includes vector V3, which considers transmission of imperfection information from the tie rods 108 to the second signal 122, i.e., the output signal of the lower component 114, of the steering system 102.

The method comprises a step 808.

In step 808, the at least one feedback is optimized as a function of the measure.

For example, feedback from the steering system 102 is optimized as a function of the measure to which the deformation is minimized.

For example, feedback from the steering system 102 is optimized as a function of the measure to minimize the time delay.

For example, feedback from the steering system 102 is optimized depending on the measure to minimize the time delay and to minimize the deformation.

In the example, parameters are determined in the optimization for which the feedback of the steering system 102 optimizes the measure after the optimization.

It may be provided that the temporal progression of the first signal 118 and/or the second temporal progression of the second signal 122 may be optimized accordingly to minimize deformation and/or minimize the time delay.

In the optimization, parameters are optionally determined for which the first signal 118 and/or the second signal 122 optimizes the measure after optimization along with feedback from the steering system 102 or independent of feedback from the steering system 102.

What is claimed is:

1. A method for optimizing at least one feedback into a steering system of a vehicle from a surface driven on by the vehicle, the method comprising:
when the surface is driven on by the vehicle, measuring a temporal progression of an excitation at a tie rod of the steering system by the surface and measuring a temporal progression of the at least one feedback of the steering system;
determining a temporal target progression of the feedback as a function of the measured temporal progression of the excitation;
determining a measure for optimization of the at least one feedback as a function of a comparison of the temporal progression of the at least one feedback with the temporal target progression; and
optimizing the at least one feedback as a function of the measure.

2. The method according to claim 1, wherein the excitation comprises a force or a moment on the tie rod of the steering system.

3. The method according to claim 1, wherein:
the at least one feedback includes a temporal progression of a force characterizing the excitation at the tie rod or a moment characterizing the excitation at the tie rod, and
the force or the moment is reported back to a driver of the vehicle when the surface is driven on by the vehicle with an operating element of the steering system as a function of the excitation of the tie rod.

4. The method according to claim 1, wherein the at least one feedback includes a temporal progression of a signal characterizing the excitation at the tie rod for determining (i) a force characterizing the excitation to the tie rod to be reported back to a driver of the vehicle when the surface is driven on, or (ii) a torque characterizing the excitation at the tie rod to be reported back to the driver of the vehicle when the surface is driven on.

5. The method according to claim 4, wherein the signal characterizes the temporal progression of the excitation of the tie rod without consideration of a steering ratio of the steering system.

6. The method according to claim 5, wherein the signal characterizes the temporal progression of the excitation of the tie rod with consideration of the steering ratio of the steering system.

7. The method according to claim 1, further comprising:
comparing an amplitude of the temporal progression of the at least one feedback with an amplitude of the target temporal progression,
wherein the measure for the optimization comprises an average percentage difference of the amplitudes determined as a function of the amplitudes when the surface is driven on by the vehicle.

8. The method according to claim 1, further comprising:
depending on the comparison, determining a time delay between the temporal progression of the at least one feedback and the temporal target progression,
wherein the measure for the optimization comprises the time delay.

9. The method according to claim 1, further comprising:
depending on the comparison, determining a deformation of the temporal progression of the at least one feedback with respect to the target temporal progression,
wherein the measure for the optimization comprises the deformation as a radius of a circle.

10. The method according to claim 9, wherein the at least one feedback is optimized as a function of the measure to minimize the deformation.

11. The method according to claim 9, wherein the at least one feedback is optimized depending on the measure to minimize a time delay.

12. The method according to claim 1, further comprising:
determining the temporal progression of the at least one feedback from the steering system as a function of parameters of at least one controller and/or at least one software function of the steering system,
wherein parameters are determined for which the at least one feedback optimizes the measure.

13. An apparatus for optimizing at least one feedback into a steering system of a vehicle via a surface driven on by the vehicle, comprising:
a device configured to perform the method according to claim 1.

14. A vehicle, comprising:
the apparatus according to claim 13.
